(19) United States
(12) Patent Application Publication
(10) Pub. No.: US 2020/0398930 A1
(43) Pub. Date: Dec. 24, 2020

(54) SOLAR-POWERED LIGHT-CHASING ELECTRIC SCOOTER

(71) Applicant: Acton, Inc., Livermore, CA (US)

(72) Inventors: Peter TREADWAY, Pleasanton, CA (US); Janelle Wang TREADWAY, Pleasanton, CA (US); Anthony GOYENECHE, Fremont, CA (US)

(21) Appl. No.: 16/784,533

(22) Filed: Feb. 7, 2020

Related U.S. Application Data
(63) Continuation-in-part of application No. 16/569,151, filed on Sep. 12, 2019.
(60) Provisional application No. 62/864,927, filed on Jun. 21, 2019.

(51) Int. Cl. B62M 6/85; B62M 6/90; B62K 19/32

(52) U.S. Cl. CPC B62M 6/85; B62K 19/32; B62M 6/90

(57) ABSTRACT

Provided is an electric scooter with a solar rechargeable battery and light chasing capability. In some embodiments, the electric scooter comprises a frame; a deck assembly attached to the frame and comprising: an upper surface, a solar panel on the upper surface of the deck, and a battery pack electrically connected to the solar panel; an electric motor electrically connected to the battery pack; one or more light sensors; and a control circuit configured to: receive data collected by the one or more light sensors; and in response to the data indicating light being detected, identify a direction towards the light.

### CROSS REFERENCE TO RELATED APPLICATIONS

The present application is a continuation-in-part of U.S. Non-provisional patent application Ser. No. 16/569,151, filed Sep. 12, 2019, entitled “ELECTRIC SCOOTER WITH TOP-SWAPPABLE BATTERY,” which claims priority to U.S. Provisional Patent Application No. 62/864,927, filed Jun. 21, 2019, entitled “ELECTRIC SCOOTER WITH TOP-SWAPPABLE BATTERY,” the disclosures thereof incorporated by reference herein in their entirety.

### TECHNICAL FIELD

This disclosure relates to generally to electric scooters, and more specifically to solar-powered light-chasing electric scooters.

### BACKGROUND

Charging batteries for electric scooters is a burden for the users. For sharable scooters, it is also a challenge, as the scooters are frequently in use, and are normally left outdoors without easy access to battery charging points, e.g., electricity outlets. The electric scooter with solar-rechargeable batteries coupled with a solar panel may be consistently charged when the solar panel (e.g., attached to the electric scooter) is placed under a source of light. However, often times the sharable scooters are left in the shade after being used (especially in urban areas), which may decrease the charging efficiency of the batteries.

### SUMMARY

In general, one aspect disclosed features an electric scooter with one or more wheels, comprising: a frame; a deck assembly attached to the frame and comprising: an upper surface, a solar panel on the upper surface of the deck, and a battery pack electrically connected to the solar panel; an electric motor electrically connected to the battery pack; one or more light sensors; and a control circuit configured to: receive data collected by the one or more light sensors; and in response to the data indicating light being detected, identify a direction towards the light.

Embodiments of the electric scooter may include one or more of the following features. In some embodiments, the control circuit may be further configured to: in response to the direction being identified, send control signals to the electric motor for moving the electric scooter towards the identified direction for a predetermined distance.

In some embodiments, the electric scooter may further comprise one or more proximity sensors.

In some embodiments, the control circuit may be further configured to: in response to the one or more proximity sensors detecting an obstacle in the identified direction within the predetermined distance, send control signals to the electric motor to stop moving.

In some embodiments, the electric scooter may further comprise a steering assembly.

In some embodiments, the control circuit may be further configured to control the steering assembly.

In some embodiments, the control circuit may be further configured to: in response to the direction being identified, send control signals to the steering assembly and the electric motor for moving the electric scooter towards the identified direction for a predetermined distance.

In some embodiments, the control circuit may be further configured to: in response to an obstacle being detected in the identified direction within the predetermined distance, send control signals to the steering assembly and the electric motor to avoid the obstacle.

In some embodiments, the frame has an opening and an upper surface; the deck assembly is configured to be lifted out of the opening of the frame from above the upper surface of the frame, and is configured to be lowered into the opening of the frame from above the upper surface of the frame; and when the deck assembly is lowered into the opening of the frame, the solar panel is exposed from the upper surface of the frame.

In some embodiments, the electric scooter may further comprise a first electrical connector, wherein the first electrical connector is electrically coupled to the electric motor; wherein the deck assembly comprises a second electrical connector, wherein the second electrical connector is electrically coupled to the battery pack; and wherein when joined together, the first and second electrical connectors electrically couple the electric motor and the battery pack.

In some embodiments, the first and second electrical connectors become electrically coupled when the removable deck assembly is lowered into the opening of the frame.

In general, one aspect disclosed features an electric scooter, comprising: a frame; a steering assembly coupled to the frame to pivot in left and right directions, the steering assembly comprises one or more wheels; an electric motor coupled to at least one of the wheels; wherein the frame comprises an opening configured to receive a removable deck assembly, wherein the removable deck assembly comprises: a deck having an upper surface and a lower surface, a solar panel attached to the upper surface of the deck, and a battery pack is electrically connected to the solar panel; one or more sensors, comprising one or more light sensors; a control circuit configured to: receive data collected by the one or more sensors; and in response to light being detected by the one or more light sensors, determine a target location under the light.

Embodiments of the electric scooter may include one or more of the following features. In some embodiments, the control circuit may be further configured to: in response to the target location being determined, send control signals to the steering assembly and the electric motor to move the electric scooter from a current location to the target location.

In some embodiments, the control circuit may be further configured to: in response to the target location being determined, determine whether to move to the target location based at least on a distance between the current location and the target location, and a remaining capacity of the battery pack.

In some embodiments, in response to the target location being determined, the control circuit may be further configured to: determine, for each of a plurality of points in time, a location of the electric scooter at the point in time; determine, based on the location of the electric scooter at the point in time and the target location, one or more movements for the electric scooter, wherein each of the movements comprises a direction and a distance; and send, to the steering assembly and the electric motor, control signals for making the one or more movements.

In some embodiments, the one or more sensors may further comprise one or more image sensors, and the control circuit may be further configured to: detect, based on the sensor data collected by the image sensors, an obstacle on a path between the current location and the target location; and determine the one or more movements to avoid the detected obstacle.

In some embodiments, the frame has an upper surface; the deck assembly is configured to be lifted out of the opening of the frame from above the upper surface of the frame, and is configured to be lowered into the opening of the frame from above the upper surface of the frame; and when the deck assembly is lowered into the opening of the frame, the solar panel is exposed from the upper surface of the frame.

In general, one aspect disclosed features an electric scooter comprising: a frame; a plurality of wheels coupled to the frame; an electric motor coupled to at least one of the wheels; wherein the frame comprises an opening configured to receive a deck assembly, wherein the deck assembly comprises: a deck having an upper surface and a lower surface, and a battery pack attached to the lower surface of the deck; and a solar panel electrically connected to the battery pack; one or more light sensors; and a control circuit configured to: receive data collected by the one or more light sensors; and responsive to receiving the data, send control signals to the electric motor for moving the electric scooter from a current location to a target location under the light.

Embodiments of the removable deck assembly may include one or more of the following features. In some embodiments, the electric scooter may further comprise a first electrical connector, wherein the first electrical connector is electrically coupled to the electric motor; wherein the battery pack comprises a second electrical connector; wherein when joined together, the first and second electrical connectors electrically couple the electric motor and the battery pack; wherein the first and second electrical connectors become electrically decoupled responsive to the deck assembly being pivoted upward from the opening of the frame of the electric scooter; and wherein the battery pack becomes removable from the electric scooter responsive to the deck assembly being pivoted upward.

In some embodiments, the first and second electrical connectors become electrically coupled responsive to the deck assembly being pivoted downward into the opening of the frame of the electric scooter.

### BRIEF DESCRIPTION OF THE DRAWINGS

FIG. 1 illustrates a solar-powered electric scooter according to embodiments of the disclosed technology.

FIG. 2 illustrates further detail of the electric scooter of FIG. 1.

FIG. 3 illustrates further detail of the sensors of FIG. 1.

FIG. 4 illustrates an example setup for a solar-powered electric scooter to navigate towards a light source.

FIG. 5 illustrates another example setup for a solar-powered electric scooter to navigate towards a light source.

FIG. 6A illustrates an example flow for a solar-powered electric scooter to chase a light source.

FIG. 6B illustrates another example flow for a solar-powered electric scooter to chase a light source.

FIG. 7 illustrates further detail of the scooter of FIGS. 1 and 2 during installation, or removal, of the deck assembly

FIG. 8 illustrates a quick twist electrical soft connector according to embodiments of the disclosed technology.

FIG. 9 illustrates a cushioned electrical connector according to embodiments of the disclosed technology.

FIG. 10 illustrates a compound locking assembly according to embodiments of the disclosed technology.

FIG. 11A illustrates a portion of the scooter during removal or installation of the deck assembly.

FIG. 11B illustrates a the retention device for the loose portions of the electrical cables of the scooter.

FIG. 12 illustrates a hidden latch mechanism for the scooter.

FIG. 13 illustrates a process for a user to install a removable deck assembly into an electric scooter according to embodiments of the disclosed technology.

FIG. 14 illustrates a process for a user to remove a removable deck assembly from an electric scooter according to embodiments of the disclosed technology.

FIG. 15 illustrates a component diagram of an example control circuit.

FIG. 16 illustrates a block diagram of an example electronic device upon which a control circuit described herein may be implemented.

### DETAILED DESCRIPTION

Embodiments of the described technology provide electric scooters having solar-powered batteries and light-detecting capabilities. In some embodiments, the batteries may form a battery pack attached to any number and any type of parts on the scooters. For example, if a scooter has a frame with a deck, the battery pack may be attached to the underside of the deck of the scooter (e.g., if the deck has a chassis, the battery pack and the chassis may form a removable deck assembly; if the deck does not have a chassis, the battery pack may still be attached to the deck); if the frame of the scooter has a bar, the battery pack may be attached to the bar. A solar panel may be electrically coupled (e.g., through a charging controller) to the battery. The deck assembly may be removed from the top of the scooter by operating a latch and lifting a handle of the assembly. The deck assembly may be returned to the scooter in a similar manner.

In some embodiments, one or more sensors may be installed on the scooter, such as light sensors for detecting lights, proximity sensors for detecting obstacles, image sensors to identifying a target location, other suitable sensors, or any combination thereof.

In some embodiments, a control circuit may be configured to receive and process sensor data collected by the sensors. The control circuit may identify a direction towards a light source detected by the sensors, a target location under the light source, detect obstacles, another suitable operation, or any combination thereof.

In some embodiments, the battery may be electrically coupled to a motor of the scooter by electrical cables and an electrical connector. The electrical connector may be a quick twist connector that is opened and closed by twisting its halves in opposite directions.

In some embodiments, instead of using electrical cables, the scooter and deck assembly may include electrical connectors that mate when the deck assembly is installed in the scooter. The electrical connectors may be surrounded by cushions that protect the connectors from micro-vibrations, dirt and water, and the like.

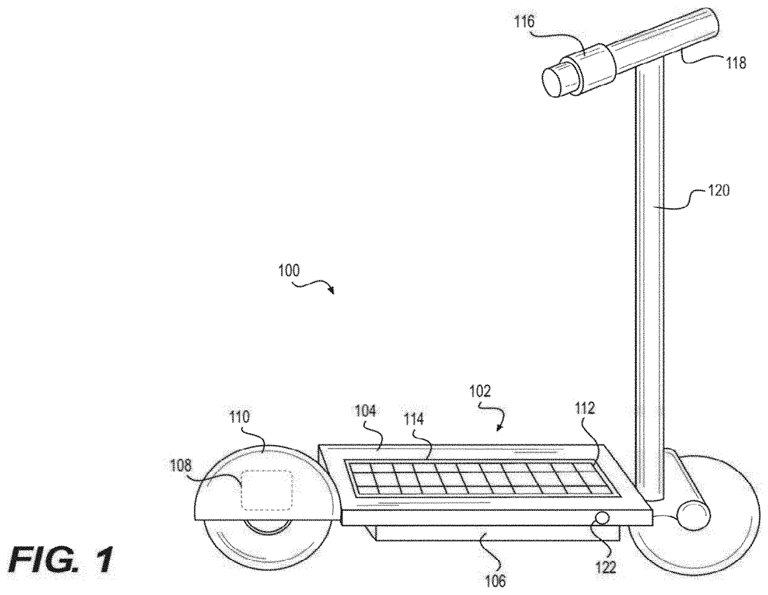

FIG. 1 illustrates an electric scooter 100 according to embodiments of the disclosed technology. Referring to FIG. 1, the scooter 100 includes a deck assembly 102 attached to a frame 104 of the scooter 100. The deck assembly 102 includes a battery case 106 mounted underneath a deck 112. The battery case 106 includes one or more batteries (not shown). The batteries are electrically coupled to an electric drive motor 108, which is protected by a housing 110. A solar panel 114 may be attached to the upper surface of the deck assembly 102, and electrically coupled with batteries in the battery case 106. The solar panel 114 may include a plurality of solar cells 112. The batteries may be charged by the solar panel 114 when the solar panel 114 is placed under a source of light, another suitable way of charging (e.g., regular plug-in charging), or any combination thereof. In some embodiments, the solar panel may be a self-adjusting solar panel that may automatically adjust its angle (e.g., through actuators) for optimization, unfurl, or the equivalent, to open up further the surface area for exposure, and/or perform another suitable self-adjusting action.

The scooter 100 in FIG. 1 may be steered by turning a handlebar 118. The speed of the motor 108 may be controlled using a throttle 116 mounted on the handlebar 118. The handlebar 118 may be connected to the frame 104 by a bar 120. One or more sensors 122 may be installed on the scooter 100 at various locations, such as on the frame 104, on the bar 120, on the handle bar 118, another suitable location, or any combination thereof.

The solar-powered electric scooter 100 depicted in FIG. 1 may also have a control circuit (not shown). The control circuit may be configured to receive data collected by the one or more sensors 122, process the received data, send control signals to control the electric motor 108 and/or steer the scooter 100.

The electric scooter 100 is depicted in FIG. 1 as having only two wheels. However, it will be appreciated that the disclosed technology applies to scooters having any number of wheels. Furthermore, it will be appreciated that the disclosed technology applies to vehicles other than scooters, and having any number of wheels.

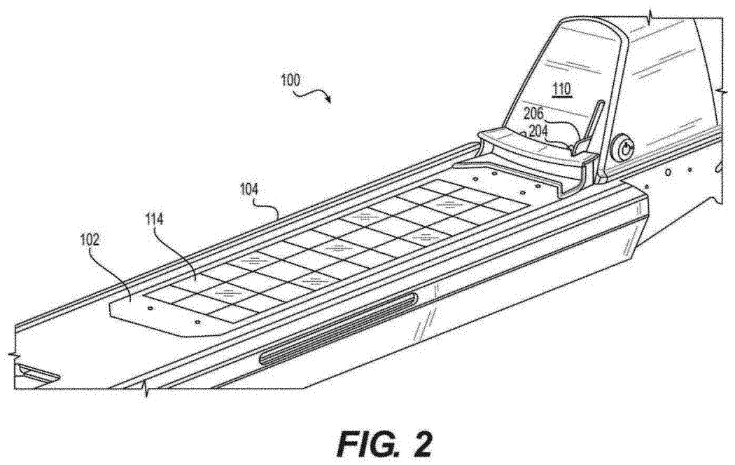

FIG. 2 illustrates further detail of the electric scooter 100 of FIG. 1. Referring to FIG. 2, the deck assembly 102 is held flush with the frame 104 by a latch 206 when engaged in a notch 204. The latch 206 may be controlled by a latch mechanism (not shown) disposed within the housing 110. In some embodiments, the solar panel 114 may be electrically connected to the battery case, where the connection (e.g., by cables or connectors) may be at one end of the deck assembly 102 opposite to the end with the latch 206.

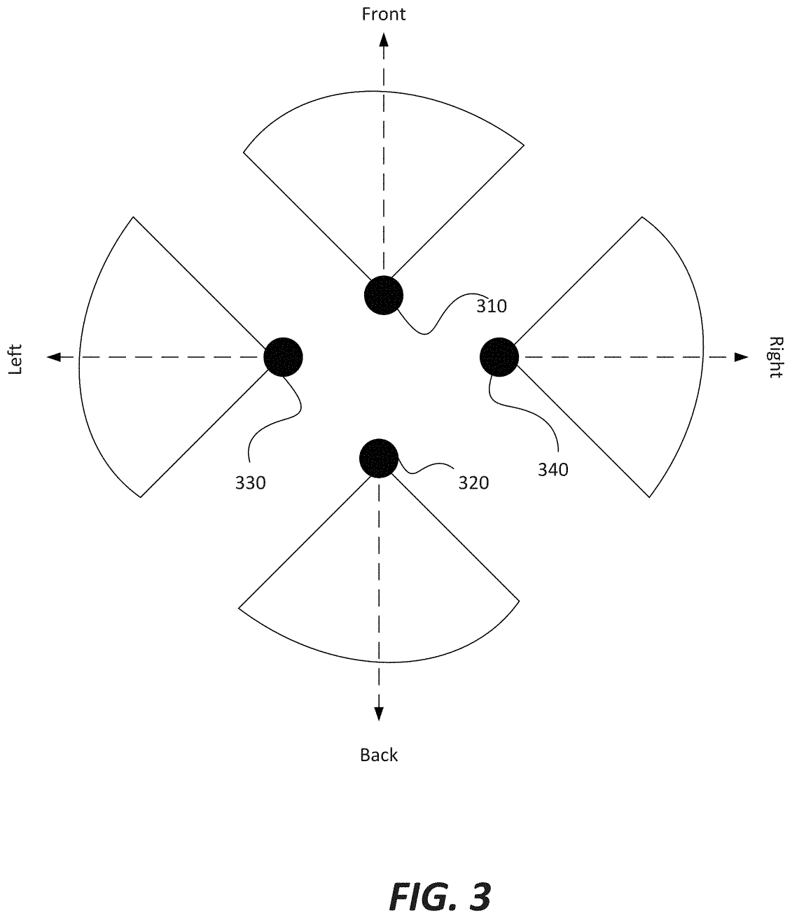

FIG. 3 illustrates further detail of the sensors 122 installed on the scooter 100 depicted in FIG. 1. The sensors 122 may be placed at various locations on the scooter 100. In some embodiments, one or more light sensors 310 may be installed on the sides of the frame of the scooter (referring back to 104 in FIG. 1), and on the bar of the scooter (referring back to 120 in FIG. 1) to detect light sources. For example, four light sensors 310, 320, 330 and 340 as shown in FIG. 3 may be installed on the four sides of the scooter frame, with each light sensor covering one of four directions (e.g., left, right, front, back). The light sensors (310, 320, 330 or 340) may convert light energy of various wavelengths into sensor data such as electrical energy or electrical signals. Based on the sensor data, the control circuit may determine a direction towards a light source. For example, the control circuit may determine the direction based on the strengthens of the signals from the four sensors. The direction may be determined as one of the four directions (e.g., left, right, front, back), or a direction that is in between of two adjacent directions (e.g., a direction towards left-front when the sensors 330 and 310 generate stronger signals).

In some embodiments, the sensor data may not be required. The control circuit may send control signals to move the scooter 100 to a location where one or more solar panels are installed, such as a permanent or temporary charging station equipped with solar panels. The scooter 100 may connect to the station to charge its batteries using the energy generated by the solar panels. The location of the station may be obtained in various ways, such as being pre-stored, pre-programmed, received from broadcasts, or received on the fly.

In some embodiments, the sensors 122 may comprise other types of sensors that may determine a target location under a light source. For example, image sensors may be installed around the scooters (e.g., on the sides of the frame of the scooter) to capture images of the surroundings. Subsequently, the light spots in the images and the corresponding brightnesses of the light spots may be determined (e.g., by using OpenCV). As another example, distance measuring sensors may be installed to measure the proximity of the brightest light spot relative to the current location of the scooter.

In some embodiments, the sensors 122 may be installed at other suitable locations, such as around the bar (referring back to 120 in FIG. 1, e.g., at the bottom of the bar), or other suitable locations.

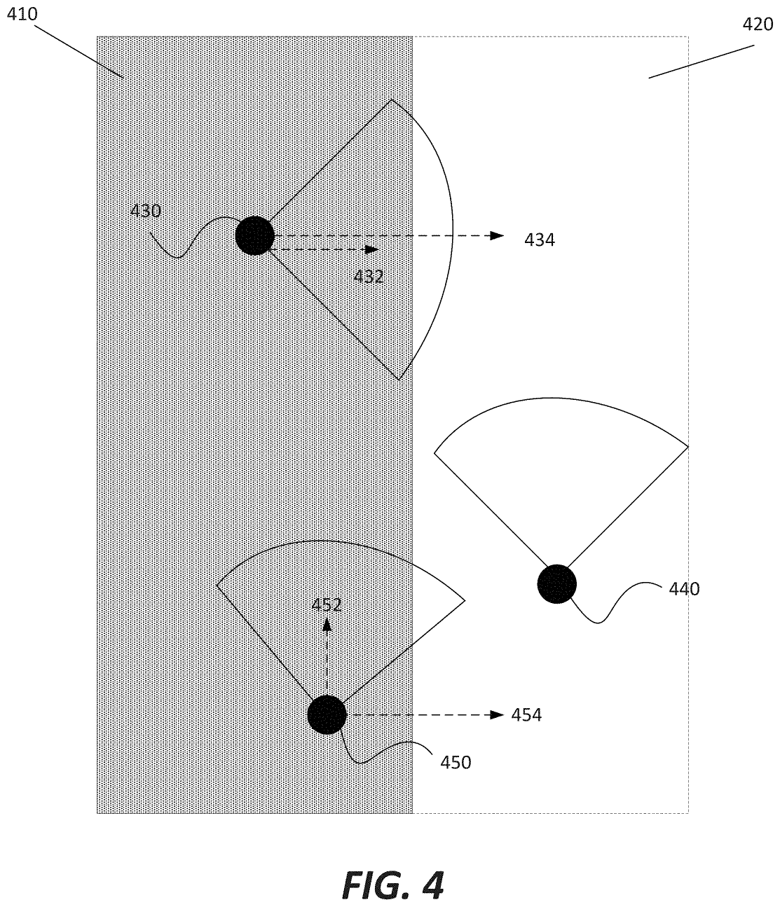

FIG. 4 illustrates an example setup for a solar-powered electric scooter to navigate towards a light source. Referring to FIG. 4, the setup has two regions 410 and 420, in which the region 410 is in shade, and the region 420 is under light. The solar-powered electric scooter disclosed in this specification may determine whether and/or how to navigate to the region 420 to charge the batteries through the solar panel.

For example, a scooter 430 in the region 410 may be facing the direction 432, and the sensors on the scooter 430 may have detected the light source in the region 420. The control circuit of the scooter 430 may, based on the sensor data, determine the light source is in the direction 434 and send corresponding control signals to the electric motor (and/or the steering assembly) of the scooter 430 to move the scooter 430 towards the direction 434.

As another example, a scooter 440 may be in the region 420. The sensors on the scooter 440 may detect the light strengths surrounding the scooter are similar (e.g., the differences are within a predetermined threshold). The control circuit of the scooter may determine that the scooter is already in the ideal location for charging the battery through the solar panel and should not move.

In yet another example, a scooter 450 in the region 410 may be facing the direction 452, and the sensors on the scooter 450 may have detected the light source in the region 420. The control circuit of the scooter 450 may, based on the sensor data, determine the light source is in the direction 454 that is different from the direction 452. The control circuit of the scooter may send a first set of control signals to steering assembly of the scooter 450 so that it changes the facing direction from 452 to 454 (e.g., the facing direction of the scooter may be determined by the sensor facing front), followed by a second set of control signals to the electric motor (and/or the steering assembly) of the scooter 430 to move towards the direction 454.

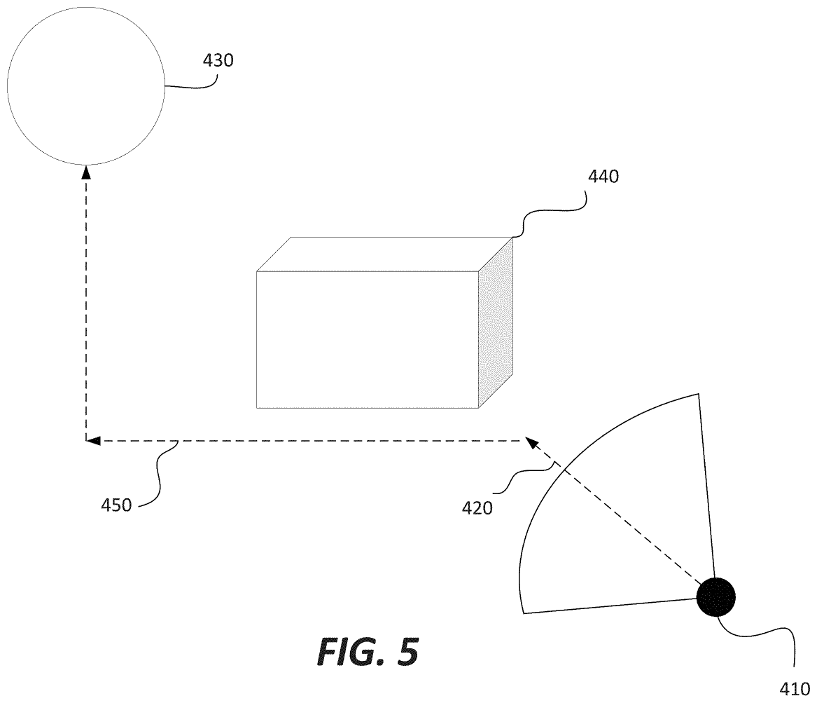

FIG. 5 illustrates another example setup for a solar-powered electric scooter 410 to navigate towards a light source. The scooter 410 in FIG. 5 may be equipped with various sensors including image sensors. The image sensors may capture images of the scooter's surroundings. The control circuit may determine a light source from the captured images, and determine a target location 430 under the light source. In some embodiments, other suitable types of sensors may be used to collect data for the control circuit to determine the target location 430.

After the target location 430 is determined, the control circuit of the scooter 410 may send control signals to the electronic motor (and the steering assembly) to navigate the scooter 410 in the direction 420 towards the target location 430. In some embodiments, the scooter 410 may detect obstacles 440 in the path between its current location and the target location 430. For example, the scooter 410 may be equipped with one or more proximity sensors that detect objects within a predetermined proximity. In response to an object 440 in the way being detected, the control circuit of the scooter 410 may adjust the navigation direction to avoid the object 440. For example, the control circuit may control the scooter to move towards a new direction 450 for a predetermined distance. This operation may be repeat for multiple times until there is no obstacle in the direction towards the target location 430.

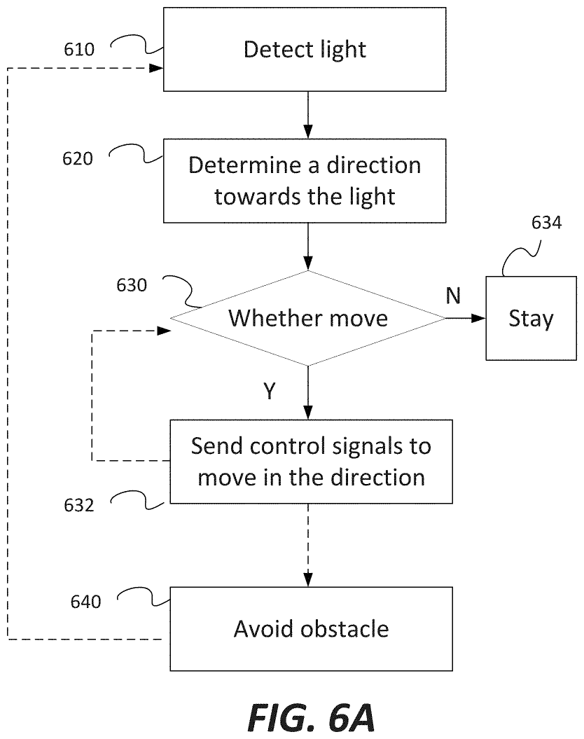

FIG. 6A illustrates an example flow for the solar-powered electric scooter to chase a light source. As shown in FIG. 6A, the example flow may start with detecting one or more light sources by using one or more sensors at step 610. In some embodiments, one or more light sensors on the scooter may be used to measure light intensities from various directions. The control circuit of the scooter may at step 620 determine a direction towards a light source based on the data collected by the one or more light sensors. For example, the control circuit may select the direction towards the light source with the highest light intensity at step 620.

In some embodiments, the control circuit of the scooter may at step 630 determine whether it should move in the direction towards the detected light source. The determination may be based on various factors, and may lead the scooter to stay at step 634. For example, if there is an object (e.g., an obstacle) in the same direction within a predetermined distance (e.g., 7 feet), the scooter stays. As another example, if the remaining capacity of the batteries is below a threshold, the scooter stays. In yet another example, if the scooter is already in a light source, the scooter stays.

In some embodiments, if the control circuit of the scooter determines to move, it may send control signals to the electric motor (and the steering assembly) to move the scooter in the direction towards the detected light source. The control signals may make the scooter move in the specific direction for a predetermined distance to a new location. In some embodiments, after the scooter moves to the new location, the sensors of scooter may collect updated data (e.g., direction towards the light source, obstacles). Based on the updated data, in some embodiments, the flow in FIG. 6A may loop back to step 630 to determine whether to move based on the updated data. In another embodiment, the flow in FIG. 6A may proceed to step 640 where the control circuit determines one or more movements to avoid the obstacle. After avoiding the obstacle, the scooter may be located in a different location. The flow in FIG. 6A may then start over again from step 610.

FIG. 6B illustrates another example flow for a solar-powered electric scooter to chase a light source. As shown in FIG. 6B, the example flow may start with detecting one or more light sources by using one or more sensors at step 660. In some embodiments, one or more image sensors may capture images from various directions. The light spots may be subsequently determined from the captured images. In some embodiments, the brightnesses (e.g., intensities) of the light spots may be compared and the one with the highest brightness may be selected as the target location under the light at step 670. It may be appreciated that there are alternative ways to determine the target location, such as using light sensors, proximity sensors, other suitable sensors, or any combination thereof.

In some embodiments, after determining the target location, the control circuit of the scooter may determine whether to move to the target location at step 680. The determination may be similar to the process described for step 630 in FIG. 6A, which may make the scooter stay at where it is at step 684. In some embodiments, the scooter may be equipped with proximity measuring sensors to measure proximities of objects relative to the scooter's current location. If the distance from the scooter's current location to the target location (e.g., obtained by measuring the distance from the current location to an object in the light spot) is beyond a threshold, the scooter stays. If, as another example, the remaining capacity of the batteries of the scooter is not sufficient to move the scooter to the target location, the scooter stays.

If the control circuit determines to move to the target location at step 680, the flow in FIG. 6B may proceed to send control signals to move at step 682. The control signals may include instructions for the scooter to make one or more movements, such as in a direction for a distance. In some embodiments, if an obstacle is observed blocking the one or more movements, the control circuit may determine a new set of movements to avoid the obstacle at step 690.

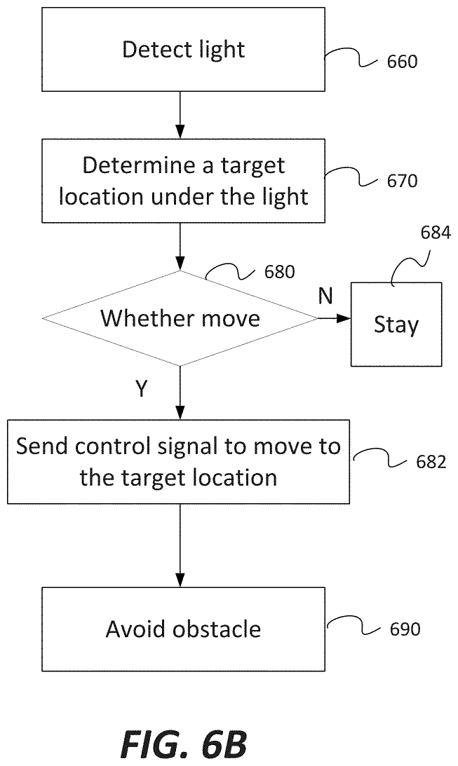

FIG. 7 illustrates further details of the scooter 100 of FIGS. 1 and 2 during installation, or removal, of the deck assembly 102. Referring to FIG. 7, the tongue 604 of the deck assembly 102 is free of the frame 104. As can be seen in FIG. 7, the frame 104 may feature a double-wall construction for rigidity and light weight. In the disclosed embodiment, a slot 702 may be formed between the walls of the frame 104 to receive the tongue 604. Also visible in the embodiment of FIG. 7 is a portion of an electrical power cable 704. The power cable 704 may provide power to the motor 108 of the scooter 100. To separate the deck assembly 102 from the scooter 100, the user may operate a connector of the power cable 704, as described in detail below. In some embodiments, the solar panel 114 in FIG. 1 may be attached to the upper surface of the deck assembly 102, the deck frame 104, or another suitable location on the scooter 100.

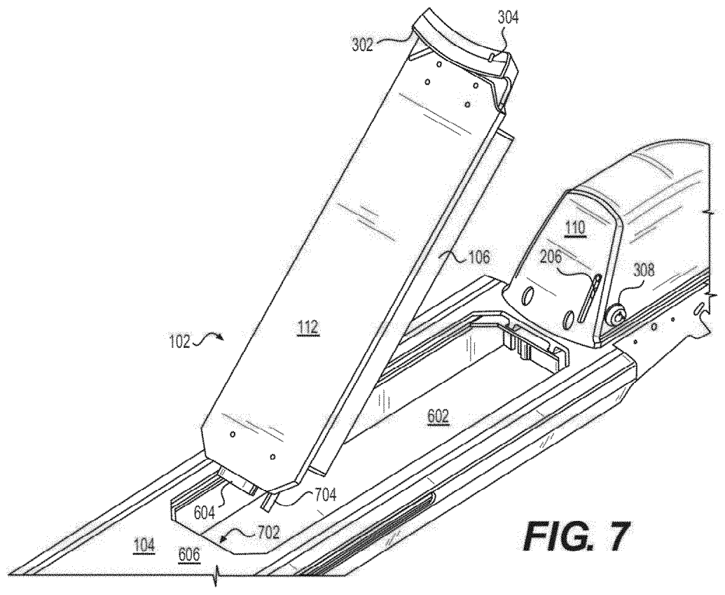

FIG. 8 illustrates a quick twist electrical soft connector according to embodiments of the disclosed technology. It may be appreciated that twist connector shown in FIG. 8 is just an exemplary type of connector may be used in some embodiments, other types of connector may well be adopted. For example, a connector that prevents the user from pulling the two halves of the connector apart (e.g., to mitigate wear over time and multiple connections and disconnections) may be used.

As used herein, the term “soft connector” is used to refer to a connector having two halves, where at least one of the halves is coupled to a flexible electrical cable. In some embodiments, the term “soft connector” is used to refer to a connector where both halves of the connector are coupled to respective flexible electrical cables. As described below, the flexible cable(s) serve to insulate the scooter from micro-vibrations, a problem unique to vehicles such as scooters that have small, hard wheels. Referring to FIG. 8, the soft electrical connector includes a male half 802 and a female half 804. The halves 802, 804 are formed at the ends of electrical cables 806, 808, respectively. The illustrated soft connector is a quick twist connector that is opened and closed by twisting its halves 802, 804 in opposite directions. Accordingly, the female half 804 of the soft connector includes a plurality of curved slots 810, each including a round opening to receive a respective locking pin (not shown) of the male half 802. The electrical connectors may be implemented in a similar manner, as shown at 812.

In some embodiments, one half of the soft connector may include a locking indicator 814. The locking indicator 814 may shine red until the soft connector is completely closed, whereupon the indicator 814 may switch to green to indicate a positive lock of the soft connector.

One advantage of the disclosed quick twist electrical soft connector is that it mitigates the problem of micro-vibrations. Vehicles such as automobiles and bicycles are subject to vibrations caused by imperfections in the road surface. Vehicles with small, hard wheels, such scooters, are subject to these vibrations, and also to micro-vibrations, which are caused by tiny imperfections in the road surface, for example such as the pebbles in a conglomerate road surface. Electrical connectors in particular are adversely affected by micro-vibrations, which cause the mating electrical parts to rub together and thereby deteriorate. Gold plating on electrical connectors is particularly subject to this deterioration. In the disclosed embodiments, the lengths of electrical cables 806, 808 isolate the electrical connector from these micro-vibrations, greatly reducing any wear the electrical connectors 812 experience.

Another advantage of the disclosed quick twist electrical soft connector is that it encourages users not to pull on the cables 806, 808 to open the soft connector. In conventional electrical connectors with no twist lock mechanism, users may be tempted to pull on the cables to open the connector. This abuse may shorten the life of the electrical cable and electrical connector considerably. But this is not possible with the twist connector. The user must grasp the soft connector halves in order to twist them in opposite directions. Consequently, the electrical soft connector and electrical cables 806, 808 may enjoy a longer lifespan.

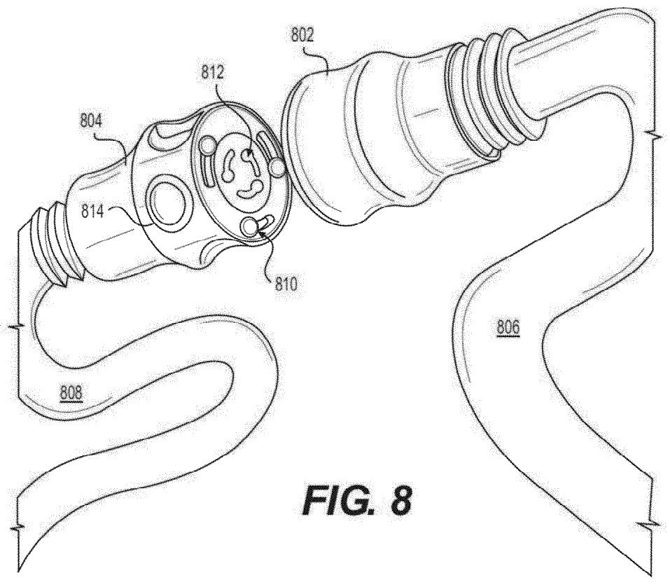

FIG. 9 illustrates a cushioned electrical connector according to embodiments of the disclosed technology. Referring to FIG. 9, a deck assembly 902 that includes a battery pack may be pressed against an elastic mounting block 904 during installation. The deck assembly 902, and the mounting block 904, include respective electrical connectors 910, 912 that are mated during installation of the deck assembly 902, thereby providing power from the battery pack to the motor through an electrical power cable 908. The mounting block 904 may be fabricated of an elastic material such as rubber to cushion the electrical connectors 910, 912 from micro-vibrations. In the embodiment of FIG. 9, the elastic mounting block 904 is disposed upon the scooter. But in other embodiments, an elastic mounting block may be disposed on the deck assembly 902 instead, or as well. For example, as shown in FIG. 9, the deck assembly 902 may include a second elastic mounting block 914 to further isolate the electrical connectors 910, 912 from micro-vibrations. These elastic mounting blocks 904, 914 may also form a seal about the electrical connectors 910, 912 that protects the electrical connectors 910, 912 from water, dirt, and the like.

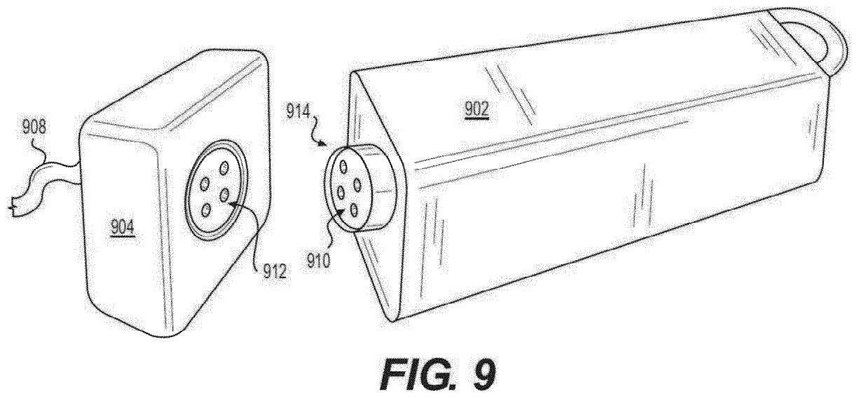

FIG. 10 illustrates a compound locking assembly according to embodiments of the disclosed technology. Referring to FIG. 10, the compound locking assembly includes a mechanical lock 1002, which may be operated by a physical key 1004 to rotate a latch 1006 into a corresponding notch, such as notch 204 in handle 302 of deck assembly 102, as shown in FIG. 3.

Referring again to FIG. 10, the compound locking assembly may also include an electric lock 1008, which may receive power through electrical cables 1010, and which may be operated using an electronic key, fob, remote control, or the like. When operated, the electric lock 1008 may insert a tab 1014 into an opening 1012 formed in the latch 1006 of the mechanical lock 1002, thereby preventing operation of the mechanical lock 1002.

In some embodiments, the electric lock 1008 may operate in parallel with the mechanical lock 1002. In such embodiments, the electric lock 1008 may insert the tab 1014 into a notch in the deck assembly. In such embodiments, both locks 1002, 1008 must be opened to release the deck assembly.

In some embodiments, the tab 1014 of the electrical lock 1008 may have multiple stops. In one of the stops, the tab 1014 engages the latch 1006 of the mechanical lock 1002, thereby preventing its operation, as illustrated in FIG. 10. In another of the stops, the tab 1014 engages a notch in the deck, thereby preventing its removal, as described above. In still another one of the stops, the tab 1014 engages neither the latch 1006 nor the deck assembly, thereby permitting operation of the mechanical lock 1002, and removal of the deck assembly.

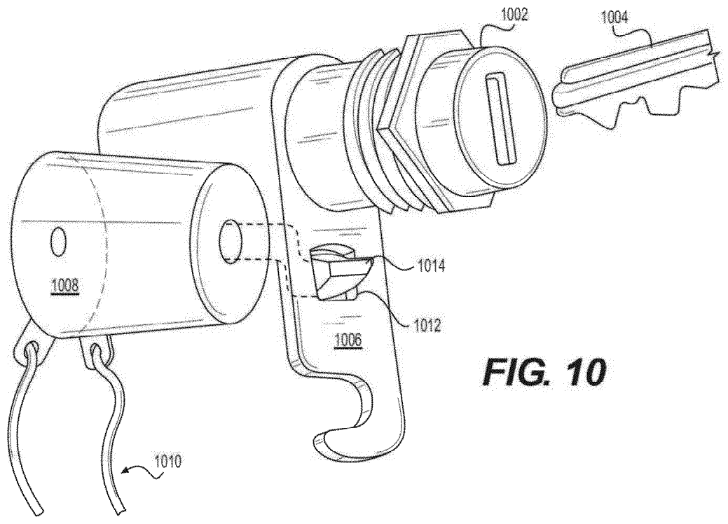

In embodiments that include an electrical power cable, the scooter may include a mechanism to retain and protect the cable when the deck assembly is installed. FIGS. 11A,B illustrate one such mechanism according to embodiments of the disclosed technology. In FIGS. 11A, B the mechanism is illustrated for the electrical cables 806, 808 and electrical connector 802, 804 of FIG. 8. However, the mechanism may be employed with any electrical cable and electrical connectors.

FIGS. 11A,B are top views of the scooter, with the rear of the scooter at the left. FIG. 11A illustrates a portion of the scooter 100 during removal or installation of the deck assembly 102. The battery pack in the deck assembly 102 is electrically coupled to the motor 108 by the electrical cables 806, 808 and the electrical connectors 802, 804. As shown in FIG. 11A, during installation or removal of the deck assembly 102, one or both of the electrical cables 806, 808 are extended to facilitate installation and removal, and to provide easy access to the electrical connectors 802, 804. A retention device 1102 permits this extension of the electrical cables 806, 808.

When the deck assembly 102 is installed in the frame 104 of the scooter 100, the retention device 1102 retracts, guides, organizes, and stores the loose portions of the electrical cables 806, 808, as shown in FIG. 11B. For example, the electrical cables 806, 808 may be retracted into a channel (not shown) formed in the frame 104 of the scooter 100. The retention device 1102 may be implemented as a spring-loaded device, for example such as a winding mechanism or the like. The winding mechanism may be similar to that used in spring-loaded tape measures, with the electrical cables 806, 808 taking the place of the tape. One benefit of this mechanism is that a technician working on the scooter does not have to manually feedback the slack in the electrical cables 806, 808, that results from the removal of the battery pack. When retracted, the electrical cables 806, 808, and the electrical connectors 802, 804, are protected from pinching, wear, and the like.

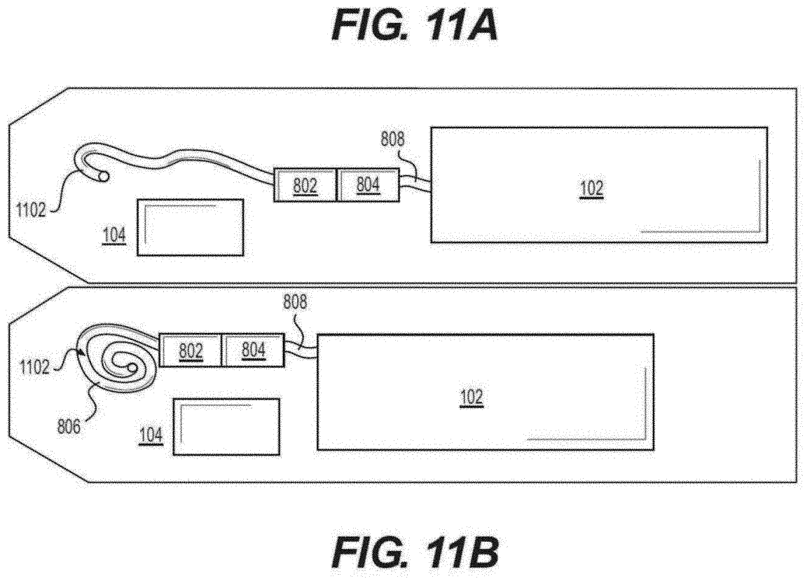

In some embodiments, the latch that retains the deck assembly 102 within the frame 104 of the scooter 100 may be hidden within a structure such as the frame 104 or the housing 110 of the scooter 100 so that it cannot be seen, and to protect the latch from damage. One such embodiment is illustrated in FIG. 12. The embodiment of FIG. 12 is illustrated for the mechanical lock 1002, physical key 1004, and latch 1006 of FIG. 10. However, the described embodiment may be employed with any lock, key, and latch, or with a keyless latch where the lock and key are replaced by a knob or the like.

Referring to FIG. 12, the described embodiment also includes a pin 1202 and a spring 1204 that biases the pin 1202 against the frame 104. When the lock 1002 and key 1004 are used to rotate the latch 1006 downward into a locked position, the latch 1006 forces the pin 1202 through a hole in the frame 104 into a notch 1206 formed in the deck assembly 102, thereby retaining the deck assembly 102 within the frame 104. When the lock 1002 and key 1004 are used to rotate the latch 1006 upward into an unlocked position, the spring 1204 backs the pin 1202 out of the notch 1206 so the deck assembly may be removed.

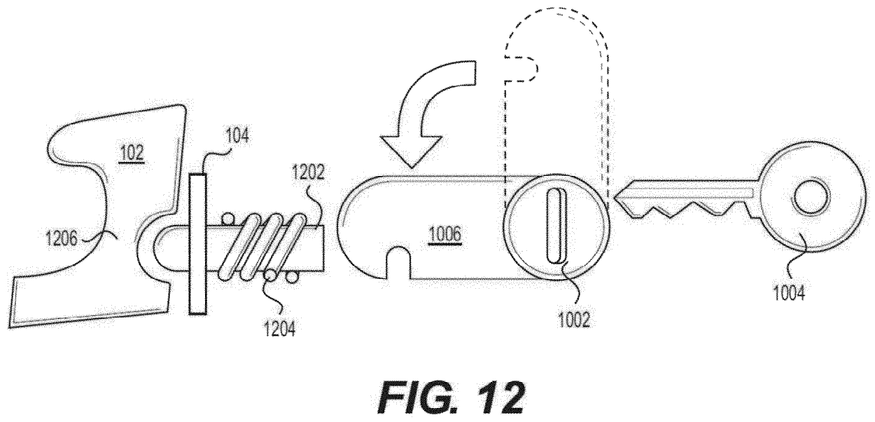

FIG. 13 illustrates a process 1300 for a user to install a removable deck assembly into an electric scooter according to embodiments of the disclosed technology. While elements of the process 1300 are described in a particular sequence, it should be understood that certain elements of the process 1300 may be performed in other sequences, may be performed concurrently, may be omitted, or any combination thereof.

Referring to FIG. 13, the user may join the electrical connector of the electric scooter with the electrical connector of the removable deck assembly, at 1302. The connectors may be joined as described above. The user may lower the removable deck assembly into the opening of the frame of the electric scooter from above the upper surface of the frame, at 1304, for example as described above. The user may secure the removable deck assembly within the frame of the electric scooter, at 1306, for example as described above.

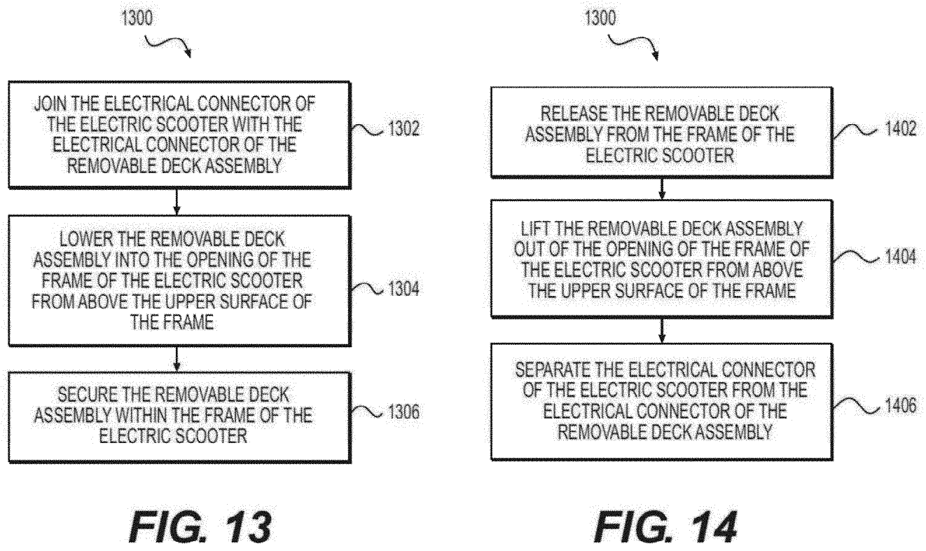

FIG. 14 illustrates a process 1400 for a user to remove a removable deck assembly from an electric scooter according to embodiments of the disclosed technology. While elements of the process 1400 are described in a particular sequence, it should be understood that certain elements of the process 1400 may be performed in other sequences, may be performed concurrently, may be omitted, or any combination thereof.

Referring to FIG. 14, the user may release the removable deck assembly from the frame of the electric scooter, at 1402, for example as described above. The user may lift the removable deck assembly out of the opening of the frame of the electric scooter from above the upper surface of the frame, at 1404, for example as described above. The user may separate the electrical connector of the electric scooter from the electrical connector of the removable deck assembly, at 1406 for example as described above. Spatially relative terms such as “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc. and are also not intended to be limiting. Like terms refer to like elements throughout the description.

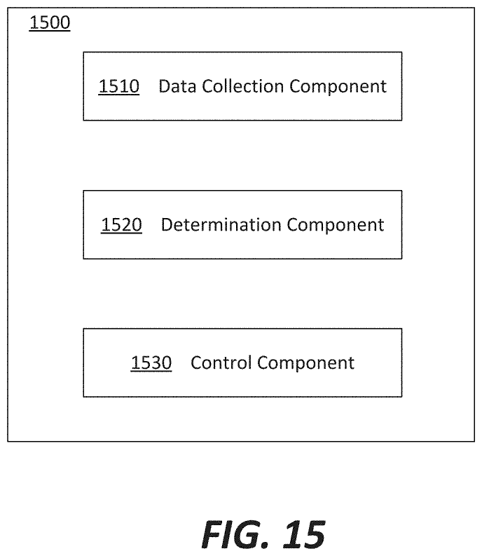

FIG. 15 illustrates a component diagram of an example control circuit. The components of the control circuit 1500 shown in FIG. 15 are intended to be illustrative. Depending on the implementation, the control circuit may include additional, fewer, or alternative components.

In some embodiments, the control circuit 1500 may a data collection component 1510, a determination component 1520, and a control component 1530. The control circuit 1500 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The control circuit 1500 may be installed with appropriate software (e.g., platform program, etc.) and/or hardware (e.g., wires, wireless connections, etc.) to access other components of the scooter 100.

In some embodiments, the data collection component 1510 may be configured to collect various data, such as sensor data collected by one or more sensors, remaining capacity of the batteries, charging efficiency of the solar panel electrically coupled with the batteries, other suitable data, or any combination thereof.

In some embodiments, the determination component 1520 may be configured to make various determinations based on the data collected by the data collection component 1510. The determinations may include identifying a light source, identifying a direction towards a light source, identifying an obstacle, determining a distance of an object or a location in relative to the scooter 100, determining one or more movements for the scooter 100, determining whether to move, other suitable determinations, or any combination thereof.

In some embodiments, the control component 1530 may be configured to send control signals to various other components of the scooter 100, such as the electric motor 108, one or more of the wheels of the scooter, a steering assembly of the scooter, another suitable component, or any combination thereof.

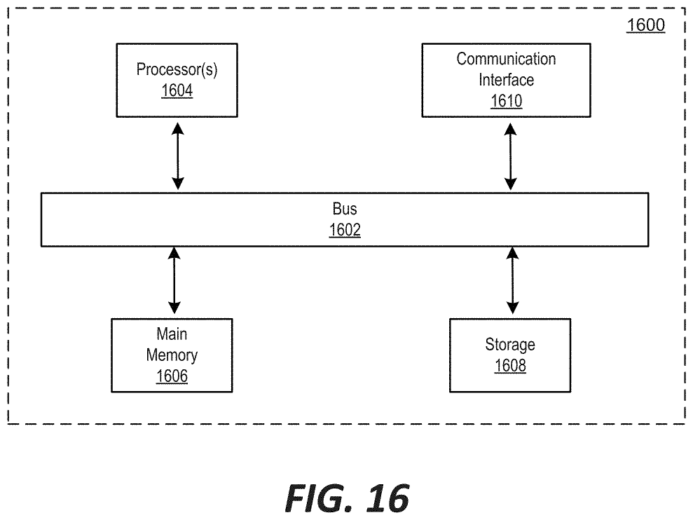

FIG. 16 illustrates a block diagram of an example electronic device 1600 upon which a control circuit described herein may be implemented. The electronic device 1600 may include a bus 1602 or other communication mechanism for communicating information, one or more hardware processor(s) 1604 coupled with bus 1602 for processing information. Hardware processor(s) 1604 may be, for example, one or more general purpose microprocessors.

The electronic device 1600 may also include a main memory 1606, such as a random-access memory (RAM), cache and/or other dynamic storage devices, coupled to bus 1602 for storing information and instructions executable by processor(s) 1604. Main memory 1606 also may be used for storing temporary variables or other intermediate information during execution of instructions executable by processor(s) 1604. Such instructions, when stored in storage media accessible to processor(s) 1604, render electronic device 1600 into a special-purpose machine that is customized to perform the operations specified in the instructions. The electronic device 1600 may further include a read only memory (ROM) 1608 or other static storage device coupled to bus 1602 for storing static information and instructions for processor(s) 1604. A storage device 1610, such as a magnetic disk, optical disk, or USB thumb drive (Flash drive), etc., may be provided and coupled to bus 1602 for storing information and instructions.

The electronic device 1600 may implement the techniques described herein using customized hard-wired logic, one or more ASICs or FPGAs, firmware and/or program logic which in combination with the electronic device causes or programs electronic device 1600 to be a special-purpose machine. According to one embodiment, the operations, methods, and processes described herein are performed by electronic device 1600 in response to processor(s) 1604 executing one or more sequences of one or more instructions contained in main memory 1606. Such instructions may be read into main memory 1606 from another storage medium, such as storage device 1610. Execution of the sequences of instructions contained in main memory 1606 may cause processor(s) 1604 to perform the process steps described herein. In alternative embodiments, hard-wired circuitry may be used in place of or in combination with software instructions.

The main memory 1606, the ROM 1608, and/or the storage device 1610 may include non-transitory storage media. The term “non-transitory media,” and similar terms, as used herein refers to media that store data and/or instructions that cause a machine to operate in a specific fashion, the media excludes transitory signals. Such non-transitory media may comprise non-volatile media and/or volatile media. Non-volatile media includes, for example, optical or magnetic disks, such as storage device 1610. Volatile media includes dynamic memory, such as main memory 1606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The electronic device 1600 may include a communication interface 1618 coupled to bus 1602. The communication interface 1618 may provide a multi-way data communication coupling to one or more connection links that are connected to one or more other components of the scooter 100.

As used herein, the terms “having,” “containing,” “including,” “comprising,” and the like are open ended terms that indicate the presence of stated elements or features, but do not preclude additional elements or features. The articles “a,” “an” and “the” are intended to include the plural as well as the singular, unless the context clearly indicates otherwise.

Although this invention has been disclosed in the context of certain implementations and examples, it will be understood by those skilled in the art that the present invention extends beyond the specifically disclosed implementations to other alternative implementations and/or uses of the invention and obvious modifications and equivalents thereof. Thus, it is intended that the scope of the present invention herein disclosed should not be limited by the particular disclosed implementations described above.

Furthermore, the skilled artisan will recognize the interchangeability of various features from different implementations. In addition to the variations described herein, other known equivalents for each feature can be mixed and matched by one of ordinary skill in this art to construct analogous systems and techniques in accordance with principles of the present invention.

It is to be understood that not necessarily all objects or advantages may be achieved in accordance with any particular implementation of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

What is claimed is:

1. An electric scooter with one or more wheels, comprising:
a frame;
a deck assembly attached to the frame and comprising:
an upper surface,
a solar panel on the upper surface, and
a battery pack electrically connected to the solar panel;
an electric motor electrically connected to the battery pack;
one or more light sensors; and
a control circuit configured to:
receive data collected by the one or more light sensors; and
in response to the data indicating light being detected, identify a direction towards the light.

2. The electric scooter of claim 1, wherein the control circuit is further configured to:
in response to the direction being identified, send control signals to the electric motor for moving the electric scooter towards the identified direction for a predetermined distance.

3. The electric scooter of claim 2, further comprising:
one or more proximity sensors.

4. The electric scooter of claim 3, wherein the control circuit is further configured to:
in response to the one or more proximity sensors detecting an obstacle in the identified direction within the predetermined distance, send control signals to the electric motor to stop moving.

5. The electric scooter of claim 1, further comprising:
a steering assembly.

6. The electric scooter of claim 5, wherein the control circuit is further configured to control the steering assembly.

7. The electric scooter of claim 6, wherein the control circuit is further configured to:
in response to the direction being identified, send control signals to the steering assembly and the electric motor for moving the electric scooter towards the identified direction for a predetermined distance.

8. The electric scooter of claim 6, wherein the control circuit is further configured to:
in response to an obstacle being detected in the identified direction within the predetermined distance, send control signals to the steering assembly and the electric motor to avoid the obstacle.

9. The electric scooter of claim 1, wherein:
the frame has an opening and an upper surface;
the deck assembly is configured to be lifted out of the opening of the frame from above the upper surface of the frame, and is configured to be lowered into the opening of the frame from above the upper surface of the frame; and
when the deck assembly is lowered into the opening of the frame, the solar panel is exposed from the upper surface of the frame.

10. The electric scooter of claim 1, further comprising:
a first electrical connector, wherein the first electrical connector is electrically coupled to the electric motor;
wherein the deck assembly comprises a second electrical connector, wherein the second electrical connector is electrically coupled to the battery pack; and
wherein when joined together, the first and second electrical connectors electrically couple the electric motor and the battery pack.

11. The electric scooter of claim 10, wherein the first and second electrical connectors become electrically coupled when the removable deck assembly is lowered into the opening of the frame.

12. The electric scooter of claim 1, wherein the control circuit is further configured to:
send control signals to the electric motor for moving the electric scooter towards a charging station where a solar panel is installed.

13. An electric scooter, comprising:
a frame;
a steering assembly coupled to the frame to pivot in left and right directions, the steering assembly comprises one or more wheels;
an electric motor coupled to at least one of the wheels;
wherein the frame comprises an opening configured to receive a removable deck assembly, wherein the removable deck assembly comprises:
a deck having an upper surface and a lower surface,
a solar panel attached to the upper surface, and
a battery pack is electrically connected to the solar panel;
one or more sensors, comprising one or more light sensors;
a control circuit configured to:
receive data collected by the one or more sensors; and
in response to light being detected by the one or more light sensors, determine a target location under the light.

14. The electric scooter of claim 13, wherein the control circuit is further configured to:
in response to the target location being determined, send control signals to the steering assembly and the electric motor to move the electric scooter from a current location to the target location.

15. The electric scooter of claim 13, wherein the control circuit is further configured to:
in response to the target location being determined, determine whether to move to the target location based at least on a distance between the current location and the target location, and a remaining capacity of the battery pack.

16. The electric scooter of claim 13, wherein in response to the target location being determined, the control circuit is further configured to:
determine, for each of a plurality of points in time, a location of the electric scooter at the point in time;
determine, based on the location of the electric scooter at the point in time and the target location, one or more movements for the electric scooter, wherein each of the movements comprises a direction and a distance; and
send, to the steering assembly and the electric motor, control signals for making the one or more movements.

17. The electric scooter of claim 16, wherein:
the one or more sensors further comprise one or more image sensors, and
the control circuit is further configured to:
detect, based on sensor data collected by the image sensors, an obstacle on a path between the current location and the target location; and
determine the one or more movements to avoid the detected obstacle.

18. An electric scooter, comprising:
a frame;
a plurality of wheels coupled to the frame;
an electric motor coupled to at least one of the wheels;
wherein the frame comprises an opening configured to receive a deck assembly, wherein the deck assembly comprises:
a deck having an upper surface and a lower surface, and
a battery pack attached to the lower surface; and
a solar panel electrically connected to the battery pack;
one or more light sensors; and
a control circuit configured to:
receive data collected by the one or more light sensors; and
responsive to receiving the data, send control signals to the electric motor for moving the electric scooter from a current location to a target location under the light.

19. The electric scooter of claim 18, further comprising:
a first electrical connector, wherein the first electrical connector is electrically coupled to the electric motor;
wherein the battery pack comprises a second electrical connector;
wherein when joined together, the first and second electrical connectors electrically couple the electric motor and the battery pack;
wherein the first and second electrical connectors become electrically decoupled responsive to the deck assembly being pivoted upward from the opening of the frame of the electric scooter; and
wherein the battery pack becomes removable from the electric scooter responsive to the deck assembly being pivoted upward.

20. The electric scooter of claim 18, wherein the first and second electrical connectors become electrically coupled responsive to the deck assembly being pivoted downward into the opening of the frame of the electric scooter.
